(19) United States
(12) Patent Application Publication
(10) Pub. No.: US 2003/0133204 A1
(43) Pub. Date: Jul. 17, 2003

(54) Design of the derotation mechanism in common-optical-path panoramic stabilized periscopes

(76) Inventors: Ping-Ho Chen, Hsinchu (TW); Yung-Shung Hung, Taoyuan Hsien (TW); Jiun-Woei Huang, Taipei (TW); Ding-Tin Lin, Taipei (TW); Chin-Kun Lou, Hsinchu Hsien (TW)

Correspondence Address: J.C. Patents, Inc., Suite 250, 4 Venture, Irvine, CA, 92618, US

(21) Appl. No.: 10/047,805

(22) Filed: Jan. 15, 2002

(51) Int. Cl. G02B 23/08; G02B 23/22; G02B 7/182; G02B 5/08

(52) U.S. Cl. 359/861; 359/850; 359/402

(57) ABSTRACT

A derotation mirror system for a common-optical-path panoramic stabilized periscope. The derotation system has a first surface-reflecting mirror, a second surface-reflecting mirror and a third surface-reflecting mirror. Through subsequent reflection of light from the surface of the first surface-reflecting mirror, the second surface-reflecting mirror, the third surface-reflecting mirror and a rotation of the entire derotation mirror system with respect to the Z-axis, the derotation is achieved. Since this invention only requires three reflections, the derotation system allows the lights with various wavebands (such as visible light, infrared light and laser beam). In addition, the derotation system manages to constrain the propagation of the output image vector and the output image vector along the same Z-axis line.

### BACKGROUND OF THE INVENTION

1. Field of Invention

This invention is related to a common-optical-path panoramic stabilized periscope system. More particularly, this invention is related to a derotation mirror system inside a common-optical-path panoramic stabilized periscope.

2. Description of Related Art

A conventional armored vehicle often has a periscope installed on and rotated by its gun turret. Generally, this kind of periscope, equipped with a CCD (charge coupled device) camera, rotates sluggishly with its turret and thus fails to acquire a panoramic sight while fast moving targets are presented. For further applications, optical sensors with different wave bands, say a thermal imager for infrared light, a laser range finder (LRF) for a laser beam, are employed and installed at various locations or mechanically integrated to a three-in-one system. Such a design of incorporating several types of sensors to the system with individual optical path will increase the overall bulk, the complexity, and the cost as well. Moreover, images captured by sensors at different wavebands are difficult to collimate onto an optical path of reference and errors must be eliminated through coordinate transformation.

Because a periscope resting on turret rotates together with the turret, the periscope is unable to rotate in response to a real time requirement. In addition, the attitude stabilization of a conventional periscope is imprecise in tracking due to its linkage to the gun ballistic drive. This is the reason why systems of common-optical-path panoramic periscope have been invented and developed.

FIG. 1 is a diagram showing a derotation prism structure inside a conventional periscope. As shown in FIG. 1, a conventional derotation prism 100 has a first plane of refraction 104, a plane of reflection 106 and a second plane of refraction 108. An input image 102 enters the prism 100 via the first plane of refraction 104. Due to a difference in refractive index between the prism 100 and the external medium, refraction occurs inside the prism 100. The refracted image is reflected by the plane of reflection 106 towards the second plane of refraction 108. After another refraction at the second plane of refraction 108, an output image 10 emerges. Since the derotation prism 100 is made of a material having a fixed refractive index, it is appropriate to apply a monochromatic light source rather than mixed lights with various wavebands to this type of derotation prism.

### SUMMARY OF THE INVENTION

Accordingly, one objective of this invention is to provide a derotation system inside a common-optical-path panoramic stabilized periscope. The optical path includes reflections only (excludes any refraction) so that the light with different wavebands (such as visible light, infrared light or laser beam) may synchronously traverse the common-optical-path within the derotation system.

To achieve these and other advantages in accordance with the purpose of the invention, as embodied and broadly described herein, the invention provides a derotation mirror system for a common-optical-path panoramic stabilized periscope. The derotation system comprises a first surface-reflecting mirror, a second surface-reflecting mirror and a third surface-reflecting mirror. Through subsequent reflections at the surface of the first surface-reflecting mirror, the second surface-reflecting mirror, the third surface-reflecting mirror and a rotation of the entire derotation mirror system with respect to the Z-axis, the derotation is achieved. Since this invention only involves three reflections, the derotation system allows the lights with different wavebands (such as visible light, infrared light and laser beam) to share the same optical path.

In this invention, a virtual reference surface is provided. This virtual reference surface is determined by an input image direction (vector). The normal vector of the virtual reference surface is parallel to input image direction. The derotation structure of the common-optical-path panoramic stabilized periscope includes a first surface-reflecting mirror, a second surface-reflecting mirror and a third surface-reflecting mirror. The intersection of the plane of the first surface-reflecting mirror, the plane of the third surface-reflecting mirror and the virtual reference surface is the first straight line through point A. The second surface-reflecting mirror and the virtual reference surface intersect at the second straight line through point B. The first straight line and the second straight line are parallel to each other but the lines are separate from each other by a suitable distance. In addition, the included angle between the first surface-reflecting mirror and the virtual reference mirror is between 45° to 90°, for example. Similarly, the included angle between the third surface-reflecting mirror and the virtual reference mirror is between 45° to 90°, for example.

In one embodiment of this invention, the included angle between the first surface-reflecting mirror and the virtual reference surface and the included angle between the third surface-reflecting mirror and the virtual reference surface are identical.

The included angle between the first surface-reflecting mirror and the virtual reference surface is preferably 60° and the included angle between the third surface-reflecting mirror and the virtual reference surface is preferably 60°.

The derotation system in this invention maintains an incoming image and a corresponding outgoing image along the same Z-axis line.

For the derotation system of this invention, if the input image rotates along the Z-axis by θ₁ due to platform yaw motion, the derotation system will rotate in the direction along the Z-axis by θ₂, where θ₂ is equivalent to −θ₂/2.

According to this invention, the counter-half rolling compensation of the derotation mirror system is implemented by a mechanism coupled to the AZ gimbal of the incident head mirror. In terms of the mechanism between the head mirror gimbal and the derotation mirror set, the latter is thus driven by the former in cases of slew derotation mode and stabilization derotation mode. A slew command is generated to the head mirror gimbal for field searching in the slew derotation mode while a rate gyroscope is employed for yaw attitude stabilization in the stabilization derotation mode.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a derotation prism structure inside a conventional stabilized periscope;

FIG. 2 is a schematic diagram showing the geometric relationship between an input image vector and a corresponding output image vector at the surface of a reflecting mirror;

FIG. 3 is another schematic diagram showing the geometric relationship between an input image vector and a corresponding output image vector at the surface of a reflecting mirror;

FIG. 4 is a schematic diagram showing a derotation structure of a common optical path panoramic stabilized periscope according to one preferred embodiment of this invention;

FIG. 5 is a schematic diagram showing an input image vector to the derotation system according to this invention;

FIG. 6 is a schematic diagram showing the output image vector from a derotation system without derotation compensation;

FIG. 7 is a schematic diagram showing the output image from a derotation system after derotation compensation;

FIG. 8 is a schematic diagram showing a reverse installation of a derotation system according to one preferred embodiment of this invention;

FIG. 9 is a block diagram showing the derotation control loop with slew derotation and stabilization derotation;

FIGS. 10 to 13 are perspective views showing the simulation results of rotating the derotation system according to this invention using the CODE V optical design software;

FIGS. 14 to 16 are a series of diagrams showing various attitude relationships between the input image, the derotation compensation angle and the output image according to this invention; and

FIGS. 17 to 21 are a series of photographs showing various attitude relationships between the input image, the derotation compensation angle and the output image obtained in the laboratory.

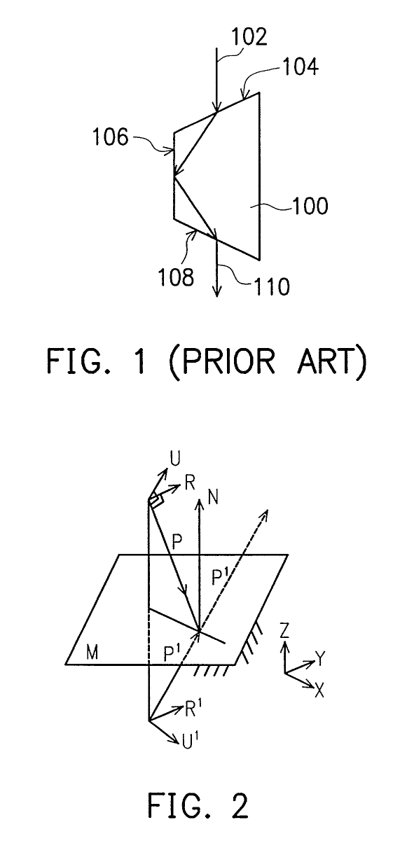

### DESCRIPTION OF THE PREFERRED EMBODIMENTS

A basis of theory and experiment is now given in detail to the present preferred embodiments of the invention, examples of which are illustrated in the accompanying drawings. Wherever possible, the same reference numbers are used in the drawings and the description to refer to the same or like parts.

FIG. 2 is a schematic diagram showing the geometric relationship between an input image vector and a corresponding output image vector at the surface of a reflecting mirror. In FIG. 2, P represents an incoming light vector, N represents an upward normal vector of the mirror surface, P¹ represents a reflected light vector and M represents a mirror reflection matrix. In addition, R represents a right vector for the incoming light vector P and U represents an up vector for the incoming light vector P.

According to FIG. 2, the reflected light vector P¹ can be represented by

P¹=2(P·N)N (1)

where P, N and P¹ are defined as follows:

$$N = [ \begin{matrix}{N}_{1} \\ {N}_{1} \\ {N}_{z}\end{matrix} ] , P = [ \begin{matrix}{P}_{x} \\ {P}_{v} \\ {P}_{z}\end{matrix} ] , {P}^{1} = [ \begin{matrix}{P}_{x}^{1} \\ {P}_{y}^{1} \\ {P}_{z}^{1}\end{matrix} ] \qquad ( 2 )$$

Since P¹ is resulted from the input vector P via the reflection of M.

P¹=MP (3).

By replacing the vector representation of P, N and P¹ into Equation (3), the mirror reflection matrix M is given as follows:

$$M = [ \begin{matrix}( 1 - 2 {N}_{x}^{2} ) & - 2 {N}_{x} {N}_{y} & - 2 {N}_{x} {N}_{z} \\ - 2 {N}_{x} {N}_{y} & ( 1 - 2 {N}_{y}^{2} ) & - 2 {N}_{y} {N}_{z} \\ - 2 {N}_{x} {N}_{z} & - 2 {N}_{y} {N}_{z} & ( 1 - 2 {N}_{z}^{2} )\end{matrix} ] = I - 2 {NN}^{T} \qquad ( 4 )$$

In the equivalent transmission matrix M=I−2NN^{T}, I is a unit matrix and N^{T} is the transpose matrix for N.

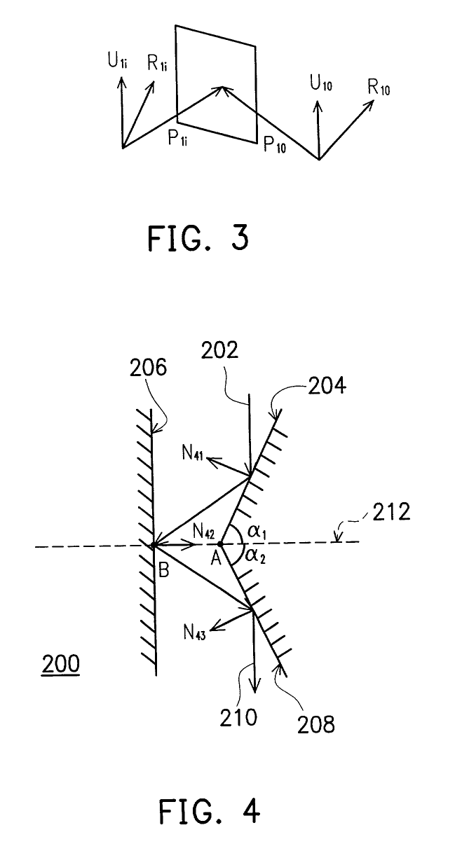

FIG. 3 is another schematic diagram showing geometric relationship between an input image vector and a corresponding output image vector at the surface of a reflecting mirror. As shown in FIG. 3, an input image vector represented by the vector P₁ᵢ is transformed into an outgoing output image vector represented by a vector P_{1O}. The upper vector U₁ᵢ of the input image is transformed into the upper vector U_{1O} of the output image. However, the right vector R₁ᵢ on the right side of the input image is transformed to a right vector R_{1O} on the left side of the output image. The transformation of an input image into an output image by a reflecting mirror surface can be explained as follows.

According to M=I−2NN^{T} and the formula M₁=I−2N₁N₁^{T} where the subscript ‘1’ in M_{1,} N₁ and N₁^{T} represents the first reflection, the following results can be obtained:

P_{1O}=M₁P₁ᵢ=(1−2N₁N₁^{T})P₁ᵢ; (5)

R_{1O}=(1−2N₁N₁^{T})R₁ᵢ; (6)

U_{1O}=(1−2N₁N₁^{T})U₁ᵢ (7)

Hence, the relationship between the input image and the output image can be given by the following transmission formula:

[P_{1O}R_{1O}U_{1O}]=(I−2N₁N₁^{T})[P₁ᵢR₁ᵢU₁ᵢ] (8)

or

[P_{1O}R_{1O}U_{1O}]=M[P₁ᵢR₁ᵢU₁ᵢ] (9)

FIG. 4 is a schematic diagram showing a derotation structure of the common optical-path panoramic stabilized periscope according to one preferred embodiment of this invention. In this embodiment, the derotation system 200 comprises a first surface-reflecting mirror 204, a second surface-reflecting mirror 206 and a third surface-reflecting mirror 208. The first surface-reflecting mirror 204 having an upward normal vector N₄₁, is positioned above the virtual reference surface 212. The second surface-reflecting mirror 206 has a normal vector N₄₂. The third surface-reflecting mirror 208 having a normal vector N₄₃ is positioned below the virtual reference surface 212. The edge of the first surface-reflecting mirror 204, the virtual reference surface 212, the third surface-reflecting mirror 208 intersect at point A. The second surface-reflecting mirror 206 and the virtual reference surface 212 intersect at point B. The included angle α₁ between the first surface-reflecting mirror 204 and the virtual reference surface 212 is between about 45° to 90°. Similarly, the included angle α₂ between the third surface reflecting mirror 208 and the virtual reference surface 212 is between about 45° to 90°. The included angles α₁ and α₂ must be identical so that both the input image 202 and the output image 210 are on the same axis. According to FIG. 4, when angles α₁ and α₂ are 60° the normal vectors N₄₁, N₄₂, N₄₃ can be represented by the following vector formula:

$${N}_{41} = [ \begin{matrix}- \sqrt{3 / 2} \\ 0 \\ 1 / 2\end{matrix} ] , {N}_{42} = [ \begin{matrix}1 \\ 0 \\ 0\end{matrix} ] , {N}_{43} = [ \begin{matrix}- \sqrt{3 / 2} \\ 0 \\ - 1 / 2\end{matrix} ] \qquad ( 10 )$$

Hence, the equivalent transmission matrices are given as follows:

M₄₁=I−2N₄₁N₄₁^{T}; (11)

M₄₂=I−2N₄₂N₄₂^{T}; (12)

M₄₃=I−2N₄₃N₄₃^{T} (13)

For the entire derotation mirror system, the assembled equivalent transmission matrix M₄ is given as follows:

$${M}_{41 =} {M}_{41} {M}_{42} {M}_{43 =} = [ \begin{matrix}- 1 & 0 & 0 \\ 0 & 1 & 0 \\ 0 & 0 & 1\end{matrix} ] \qquad ( 14 )$$

However, the input image submitted to the common-optical-path panoramic stabilized periscope must go through an input head mirror (M₁), a parabolic reflecting mirror (M₂), a field magnifying mirror (M₃) before arriving at the derotation mirror system (M₄). Therefore, the output image (P_{3O}, U_{3O}, R_{3O}) from the field magnifying lens (M₃) is equivalent to the input image (P₄ᵢ, U₄ᵢ, R₄ᵢ) to the derotation mirror system (M₄).

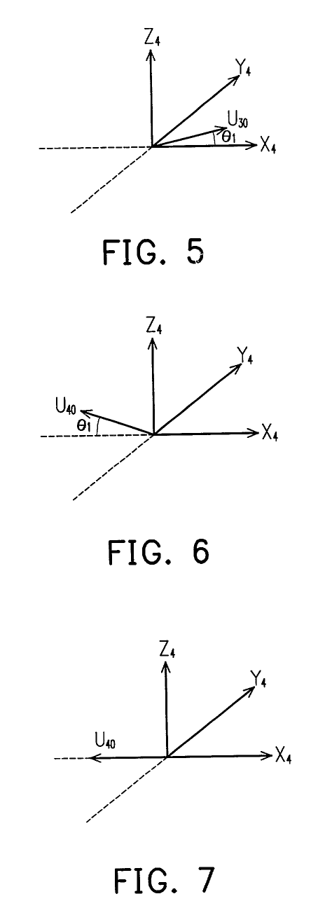

FIG. 5 is a schematic diagram showing input image at the derotation system according to this invention. FIG. 6 is a schematic diagram showing the output image from a derotation system without any angular compensation. In FIG. 5, if the up vector U_{3O} of the output image from the field magnifying mirror (M₃) faces the positive direction of the axis X₄ and Y₄ at an angle θ₁ from the X₄ axis, the output image after passing through the derotation mirror system with an equivalent transmission M₄ produces an up vector U_{4O} that faces the negative direction of the X₄ axis, the positive direction of the Y₄ axis and at an angle θ₁ from the negative X₄ axis. The output image is represented by the following matrix formula:

$${U}_{40} = {M}_{4} {U}_{4 i} = {M}_{4} {U}_{30} == [ \begin{matrix}- m cos {θ}_{1} \\ m sin {θ}_{1} \\ 0\end{matrix} ] \qquad ( 15 )$$

FIG. 7 is a schematic diagram showing the output image from a derotation system after angular compensation. After a θ₂ rotation with respect to the Z₄ axis by the derotation mirror system, the output image is parallel to the negative direction of the X₄ axis. The equivalent transmission matrix for rotating θ₂ with respect to the Z₄ axis is given by:

M_{4θ2}=R_{θ2}M₄R_{θ2}^{T} (16)

where R_{θ2}^{T} is the transpose matrix of the rotation matrix R_{θ2} and the rotation matrix R_{θ2} is given by:

$$\begin{matrix}{R}_{θ2} = [ \begin{matrix}cos {θ}_{2} & sin {θ}_{2} & 0 \\ - sin {θ}_{2} & cos {θ}_{2} & 0 \\ 0 & 0 & 1\end{matrix} ] \\ from & ( 17 ) \\ m [ \begin{matrix}- 1 \\ 0 \\ 0\end{matrix} ] = {M}_{4 θ2} [ \begin{matrix}m cos {θ}_{1} \\ m sin {θ}_{1} \\ 0\end{matrix} ] \\ we have & ( 18 ) \\ [ \begin{matrix}cos {θ}_{2} \\ sin {θ}_{2} \\ 0\end{matrix} ] = [ \begin{matrix}cos ( {θ}_{1} + {θ}_{2} ) \\ - sin ( {θ}_{1} + {θ}_{2} ) \\ 0\end{matrix} ] & ( 19 )\end{matrix}$$

According to the above formula, θ₂=−θ₁/2. Thus, the compensation angle of the derotation mirror system is θ₁/2 with a direction of rotation just opposite to the rotation of the input head mirror frame. In other words, if the input head mirror (M₁) frame rotates clockwise by θ₁ with respect to the Z₄ axis, the derotation mirror system rotates counter-clockwise by θ₂, that is, −θ₁/2.

FIG. 8 is a schematic diagram showing a reverse installation of a derotation system according to one preferred embodiment of this invention. If the derotation system is installed in reverse, the equivalent transmission matrix M₄_{_{—}}_{180°} is given by the following formula:

$${M}_{4 \_ {180}^{°}} = {R}_{{180}^{°}} {M}_{4} {R}_{{180}^{°}}^{T} = [ \begin{matrix}- 1 & 0 & 0 \\ 0 & - 1 & 0 \\ 0 & 0 & 0\end{matrix} ] [ \begin{matrix}- 1 & 0 & 0 \\ 0 & 1 & 0 \\ 0 & 0 & 1\end{matrix} ] [ \begin{matrix}- 1 & 0 & 0 \\ 0 & - 1 & 0 \\ 0 & 0 & 0\end{matrix} ] = [ \begin{matrix}- 1 & 0 & 0 \\ 0 & 1 & 0 \\ 0 & 0 & 1\end{matrix} ] = {M}_{4} \qquad ( 20 )$$

From the above formula, overall equivalent transmission matrix will remain unchanged no matter if the plane of reflections are placed before or after the planar reflecting mirror in the derotation system. Hence, the compensation angle is always −θ₁/2 for the derotation system.

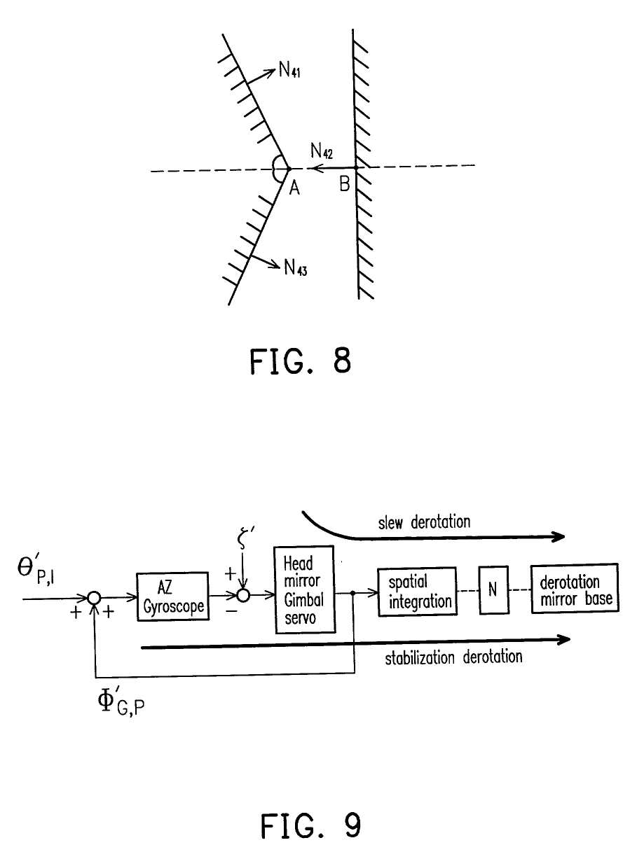

FIG. 9 is a block diagram showing a combined compensation of the slew derotation and the stabilization derotation in a derotation system. The real-time response of the derotation system according to this invention is subject to the compensation angle in the derotation system. An AZ rate gyroscope is introduced to compensate for the dynamic angular rate of the platform and stabilize the derotation position. In FIG. 9, θ′_{p,I} is the rate of the platform with respect to an inertial frame, ζ′ is a slew rate command, Φ!_{G,P} is the rate of the gimbal relative to the platform and N is −½.

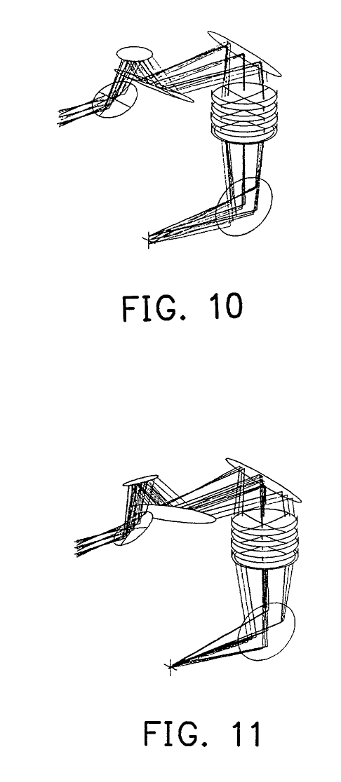

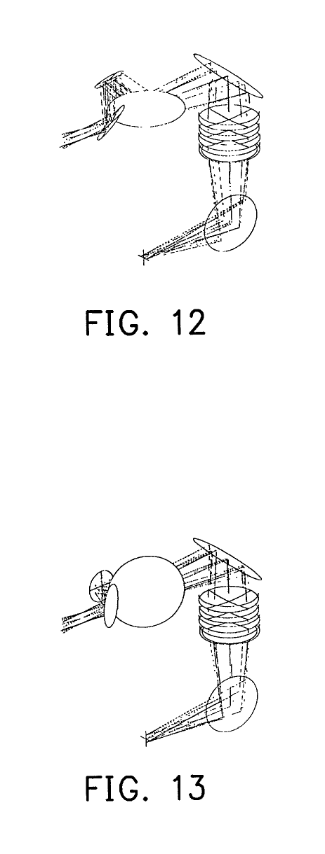

FIGS. 10 to 13 are perspective views showing the results of simulating the angular derotation according to this invention by using the CODE V optical design software. The simulation assumes the reticle is on the original aiming surface. The derotation mirror set is regarded as a single unit rotating about its axis and image is observed through an extended mirror set. FIG. 10 shows the derotation mirror and the incoming image stationed at zero degrees relative to each other. FIG. 11 shows the output image rotated by 45 degrees when the derotation mirror rotates by 22.5 degrees. FIG. 12 shows the output image rotated by 90 degrees when the derotation mirror rotates by 45 degrees. FIG. 13 shows the output image rotated by 180 degrees when the derotation mirror rotates by 90 degrees. In general, for every θ rotation of the input image on the aiming surface via the derotation mirror, the output image will rotate by 2θ.

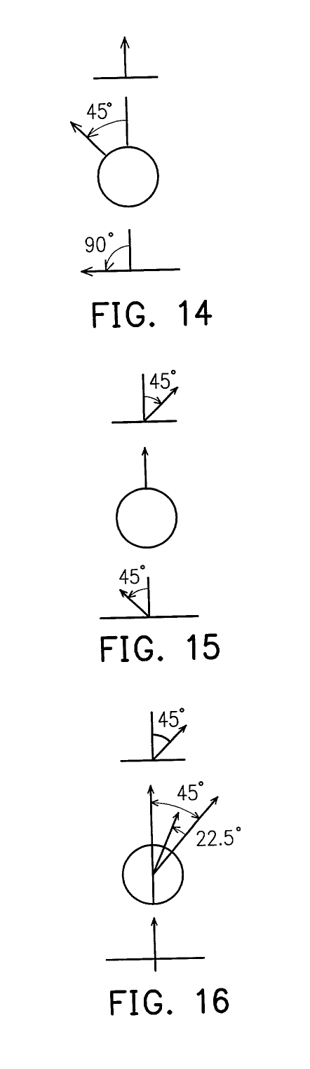

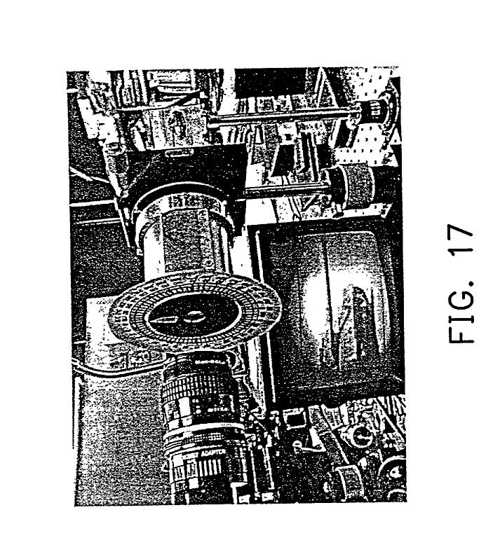

FIGS. 14 to 16 are a series of diagrams showing various relationships between the input image, the derotation compensation angle and the output image according to this invention. First, as shown in FIG. 14, the results of simulation (FIGS. 10 to 13) show that if the derotation mirror set rotates clockwise 45 degrees without rotating the input image, the output image will rotate clockwise by 90 degrees. When the input image rotates clockwise by 45 degrees without moving the derotation mirror system as shown in FIG. 15, the output image will rotate anti-clockwise by 45 degrees. On the other hand, if the input image rotates clockwise by 45 degrees and the derotation mirror set rotates counter-clockwise by 22.5 degrees (half-angle) as shown in FIG. 16, the output image will maintain a vertical polarity.

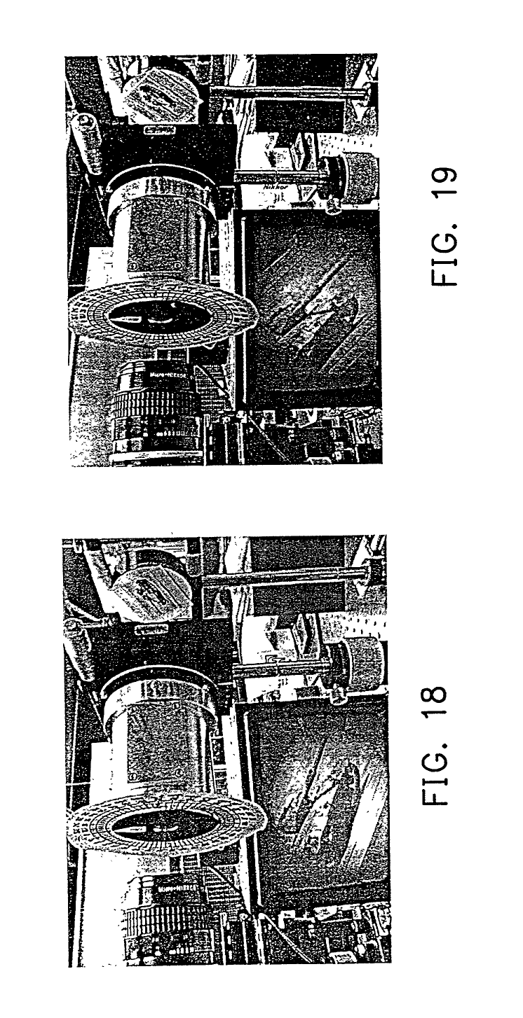

FIGS. 17 to 21 are a series of photographs showing various relationships between the input image, the derotation compensation angle and the output image obtained from some actual tests. As shown in FIG. 17, when the input image and the derotation mirror are in a normal uncontrolled state, both the vertical polarity of the input and output images are pointed upwards but with left/right side reversed. As shown in FIG. 18, when the input image rotates counter-clockwise by 22.5 degrees and the derotation mirror is in a normal uncontrolled state, the vertical polarity of the input image will rotate counter-clockwise by 22.5 degrees and the vertical polarity of the output image will rotate clockwise by 22.5 degrees. Again, the input image and the output image are left/right reversed. As shown in FIG. 19, when input image rotates counter-clockwise by 45 degrees and the derotation mirror is in a normal uncontrolled state, the vertical polarity of the input image will rotate counter-clockwise by 45 degrees and the vertical polarity of the output image will rotate clockwise by 45 degrees. The input and output image are left/right reversed.

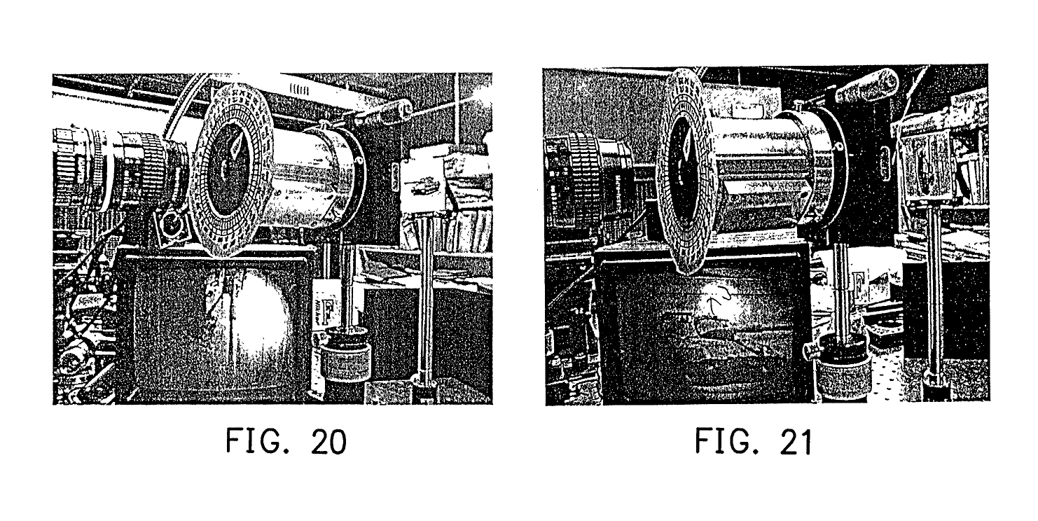

As shown in FIG. 20, when the input image maintains a normal state and the derotation mirror rotates clockwise by 45 degrees, the vertical polarity of the input image is pointed upwards and the vertical polarity of the output image rotates clockwise by 90 degrees. The input image and the output image are left/right reversed. This authenticates the aforementioned CODE V simulation. As shown in FIG. 21, when the input image rotates counter-clockwise by 90 degrees and the derotation mirror rotates clockwise by 45 degrees, the vertical polarity of the input image will rotate counter-clockwise by 90 degrees and the vertical polarity of the output image is pointed upwards. Similarly, the input image and the output image are left/right reversed. Again, this authenticates the erection of the output image by a counter half-angle rotation of the derotation mirror.

In conclusion, the advantages of the derotation structure inside a common-optical-path panoramic stabilized periscope according to this invention includes:

1. The derotation structure utilizes light reflection without any refraction so that the light with various wavebands (such as visible light, infrared light or laser beam) may share a common optical path within the derotation mirror set.

2. The derotation structure maintains both the input image and the output image along the same axis.

3. The periscope may acquire an erected output image by a mechanism linked to the head mirror gimbal so as to have counter half-angle compensation in case of slew derotation.

4. The periscope may also utilize an additional gyroscope on the head mirror gimbal to measure the angular rate comprising platform yaw rate so as to keep the output image erectly stable in case of stabilization derotation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A derotation mirror system within a common-optical-path panoramic stabilized periscope for receiving an input image in a direction perpendicular to a virtual reference surface, the derotation system comprising:
a first surface-reflecting mirror positioned above the virtual reference surface at a first included angle from the virtual reference surface;
a second surface-reflecting mirror perpendicular to the virtual reference surface, wherein the second surface-reflecting mirror and the virtual reference surface intersect along a first straight line; and
a third surface-reflecting mirror positioned below the virtual reference surface at a second included angle from the virtual reference surface, wherein an edge of the first surface-reflecting mirror, the virtual reference surface and an edge of the third surface-reflecting mirror intersect along a second straight line, and the input image is converted to an output image after several reflections via the first surface-reflecting mirror, the second surface-reflecting mirror and the third surface-reflecting mirror.

2. The derotation system of claim 1, wherein the first included angle and the second included angle are identical.

3. The derotation system of claim 1, wherein a value of the first and the second included angle is between about 45° and 90°.

4. The derotation system of claim 1, wherein the derotation system is capable of rotating about a Z-axis.

5. The derotation system of claim 4, wherein the derotation system is capable of effecting a reverse half-angle compensation for slew angular rotation.

6. The derotation system of claim 4, wherein the derotation system is capable of effecting a reverse half-angle compensation for platform angular rotation.
